(19) United States
(12) Patent Application Publication
(10) Pub. No.: US 2026/0300269 A1
(43) Pub. Date: Oct. 1, 2026

(54) SYSTEMS AND METHODS FOR PROVIDING AN ENHANCED USER INTERFACE FOR SELECTING USER INTERFACE ELEMENTS AND GENERATING A QUERY BASED ON THE SELECTION

(71) Applicant: Verizon Patent and Licensing Inc., Basking Ridge, NJ (US)

(72) Inventor: Saikiran N. CHAVALI, Pune (IN)

(73) Assignee: Verizon Patent and Licensing Inc., Basking Ridge, NJ (US)

(21) Appl. No.: 19/090,769

(22) Filed: Mar. 26, 2025

(51) Int. Cl. G06F 16/242; G06F 3/0482; G06F 3/0484; G06F 40/40

(52) U.S. Cl. CPC G06F 16/242; G06F 3/0482; G06F 3/0484; G06F 40/40

(57) ABSTRACT

A device may receive coordinates and properties of a user selection provided around one or more objects displayed on a digital surface, and may identify the one or more objects within the user selection based on the coordinates. The device may generate a query based on the properties of the user selection and the one or more objects, and may process the query, with a large language model, to generate a response to the query. The device may perform one or more actions based on the response.

### BACKGROUND

In the contemporary digital age, interaction between users and digital interfaces is a vital aspect of the user experience. Traditional methods of interaction typically involve clicking, hovering, touching, voice commands, and gestures.

### BRIEF DESCRIPTION OF THE DRAWINGS

FIGS. 1A-1G are diagrams of an example associated with providing an enhanced user interface for selecting user interface elements and generating a query based on the selection.

FIG. 2 is a diagram of an example environment in which systems and/or methods described herein may be implemented.

FIG. 3 is a diagram of example components of one or more devices of FIG. 2.

FIG. 4 is a flowchart of example process for providing an enhanced user interface for selecting user interface elements and generating a query based on the selection.

### DETAILED DESCRIPTION OF EXAMPLE EMBODIMENTS

The following detailed description of example implementations refers to the accompanying drawings. The same reference numbers in different drawings may identify the same or similar elements.

Current digital interaction systems have limitations, particularly when simultaneously engaging with multiple displayed elements or when conveying a specific user intent through drawing tools. For example, when shopping online or navigating through dense information on web pages, users often face challenges in efficiently conveying their preferences or inquiries. This inefficiency may lead to a cumbersome and time-consuming experience, as users must navigate through multiple pages or use numerous filters to find desired information. Moreover, the current systems do not provide users with the flexibility of freeform selection and querying of multiple objects or elements on digital surfaces. The lack of intuitive and efficient interaction methods can hinder the speed and efficacy of obtaining information, as well as limit the potential for a more personalized and engaging user experience. The interactive process can be resource-intensive and not conducive to rapid, on-the-spot information retrieval or sharing, which modern users increasingly expect.

Thus, current techniques for retrieving information may consume computing resources (e.g., processing resources, memory resources, communication resources, and/or the like), networking resources, and/or other resources associated with providing a poor user experience associated with locating information, failing to determine an intent of a user searching for information, providing incorrect information to the user based on failing to determine the intent of the user, handling user complaints associated with providing incorrect information, handling lost customers associated with providing incorrect information, and/or the like.

Some implementations described herein provide an enhanced user interface for selecting user interface elements and generating a query based on the selection. For example, a device (e.g., a query system and/or a user device) may receive coordinates and properties of a user selection provided around one or more objects displayed on a digital surface, and may identify the one or more objects within the user selection based on the coordinates. The device may generate a query based on the properties of the user selection and the one or more objects, and may process the query, with a language model (LM), to generate a response to the query. In some implementations, the user may enter a user query about the selection and the LM may generate a response to the user query. The device may perform one or more actions based on the response(s). In some implementations, the properties of the user selection may include, but are not limited to, a color, a stroke pattern, a stroke width, or a stroke dash type, which are associated with intents utilized to generate the query.

In this way, the device provides an enhanced user interface for selecting user interface elements and generating a query based on the selection. For example, the device may provide a form of interaction that goes beyond mere point-and-click or single element selection. The device may accurately interpret user intent through freeform drawing gestures, and may provide relevant information while enhancing the overall user experience. By interpreting gestural inputs to generate queries, the device may minimize a need for textual input and may reduce a quantity of steps typically required to obtain information. By streamlining the interaction process, the device may be advantageous in environments with high data throughput, such as e-commerce platforms, digital catalogs, and multimedia applications, and may be utilized for bill queries, mapping particular gestures to particular types of parameters to an LLM, and/or the like. Thus, the device may conserve computing resources, networking resources, and/or other resources that would have otherwise been consumed by failing to determine an intent of a user searching for information, providing incorrect information to the user based on failing to determine the intent of the user, handling user complaints associated with providing incorrect information, handling lost customers associated with providing incorrect information, and/or the like.

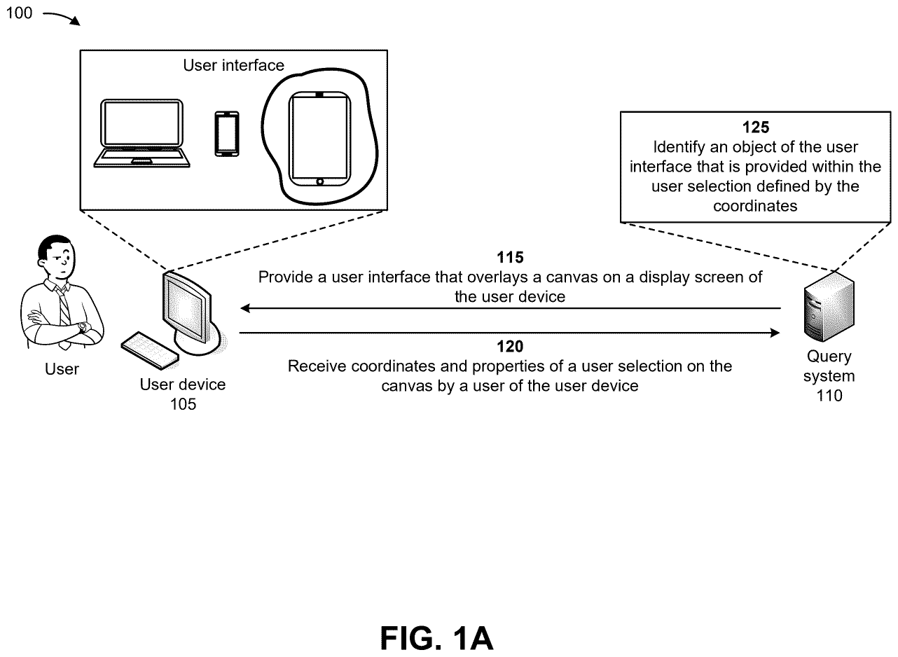

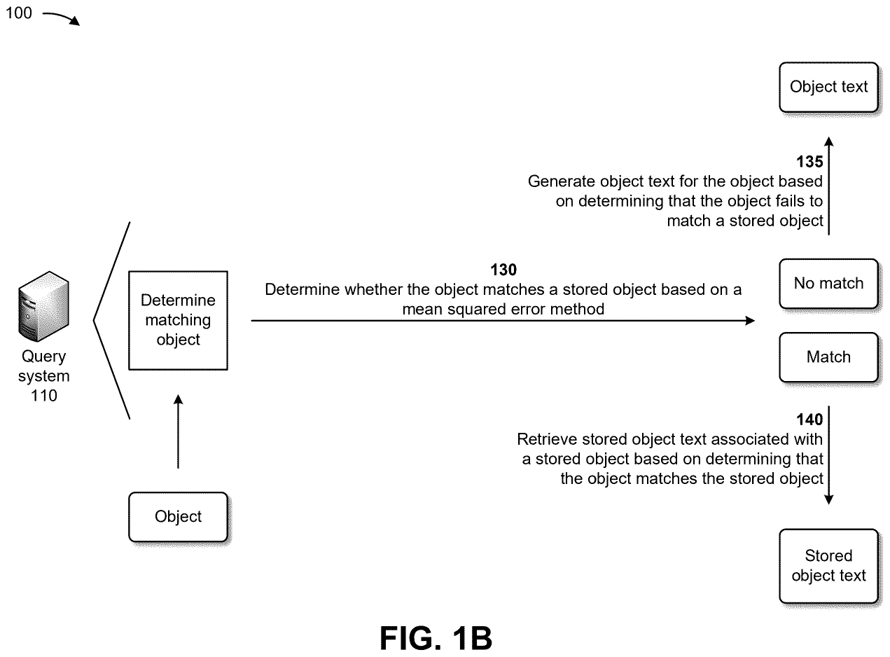

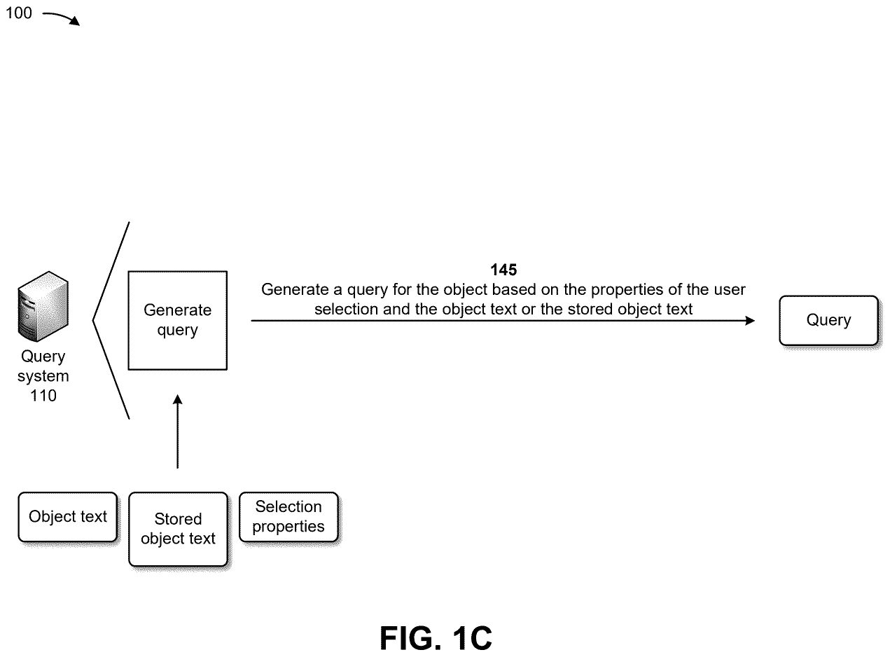

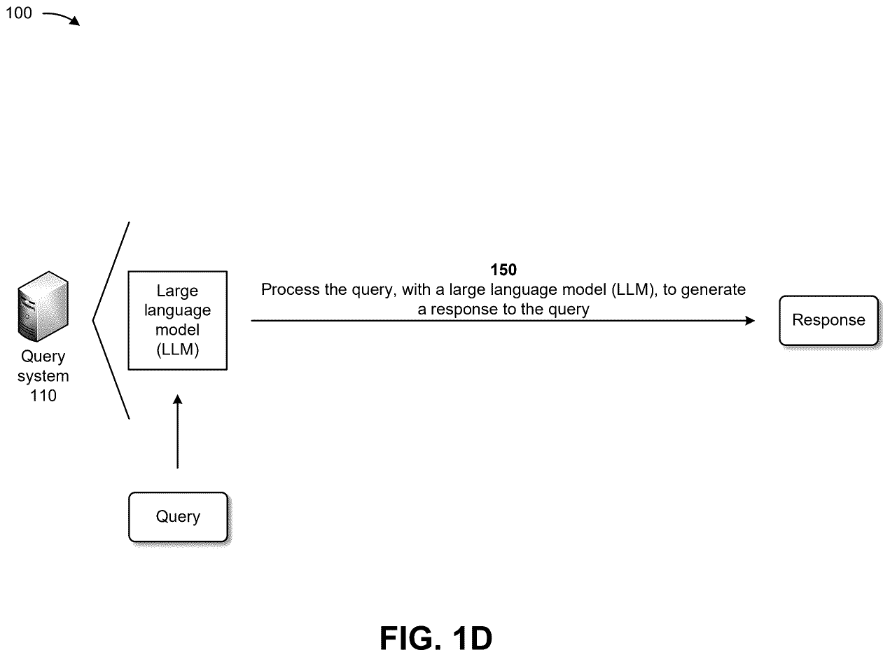

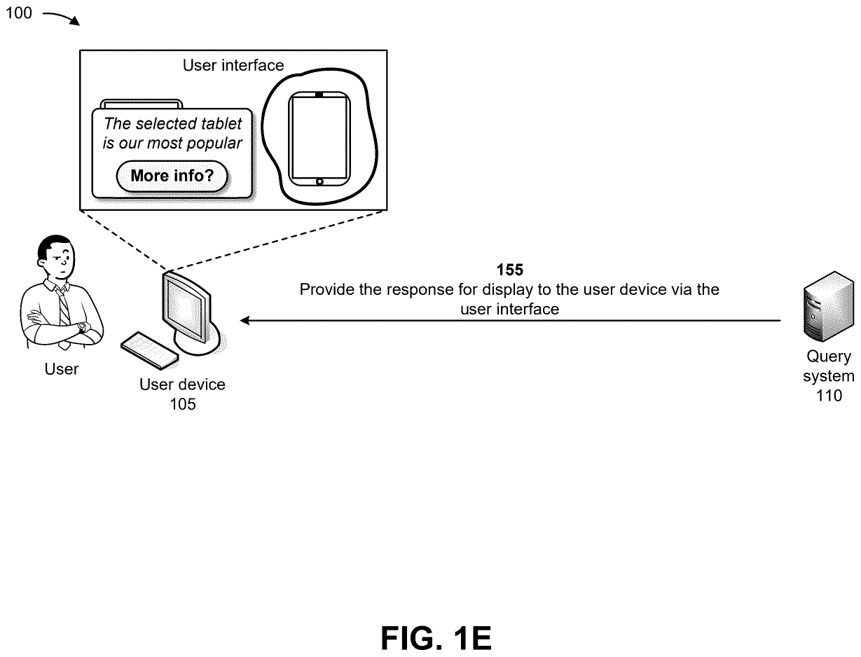

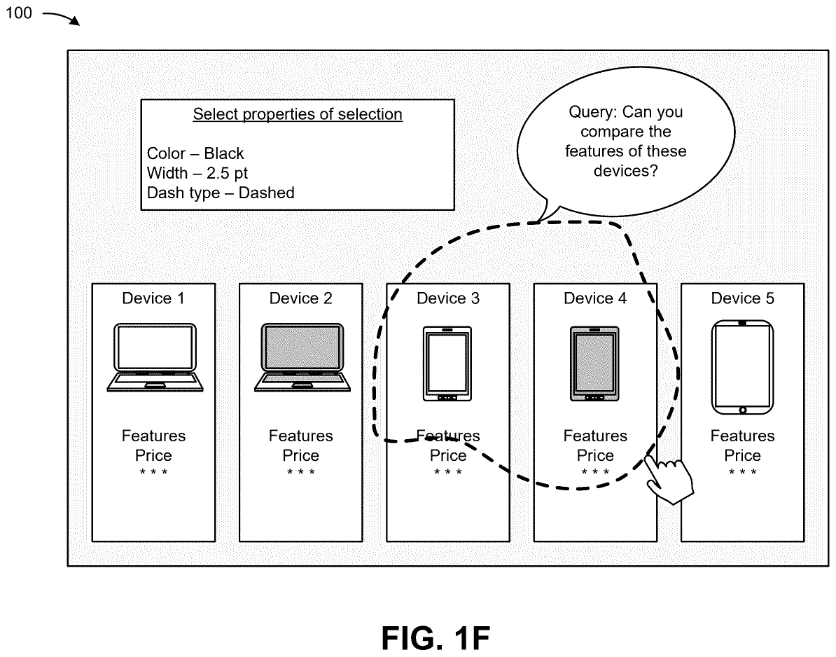

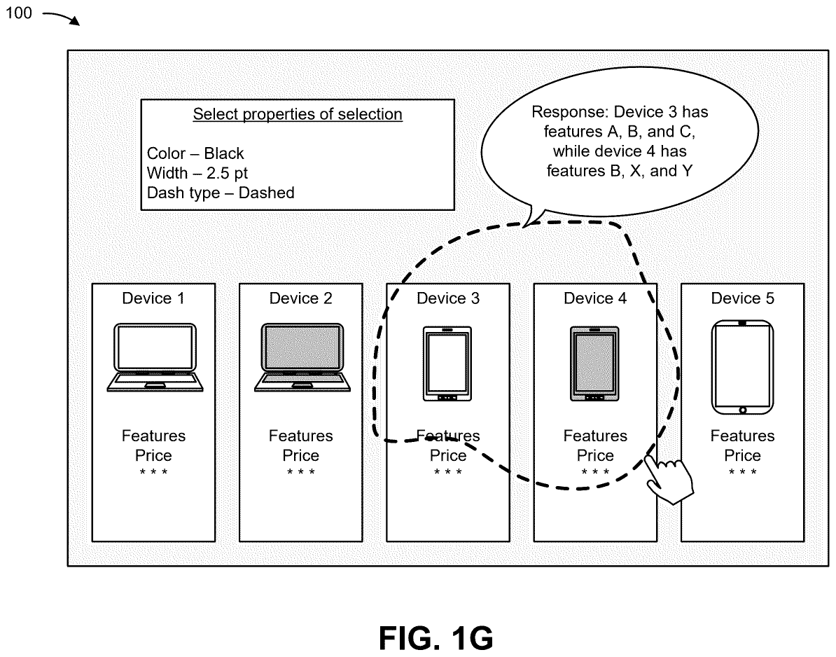

FIGS. 1A-1G are diagrams of an example 100 associated with providing an enhanced user interface for selecting user interface elements and generating a query based on the selection. As shown in FIGS. 1A-1G, the example 100 includes a user device 105 (e.g., associated with users) and a query system 110. Further details of the user device 105 and the query system 110 are provided elsewhere herein. In some implementations, one or more of the functions described herein as being performed by the query system 110 may be performed by the user device 105.

As shown in FIG. 1A, and by reference number 115, the query system 110 may provide a user interface that overlays a canvas on a display screen of the user device 105. For example, the user and the user device 105 may be associated with a domain in which the user is present or that is generated by the query system 110. In some implementations, the domain may include a video display provided to the user via the user device 105. In such implementations, the video display may include one or more user interfaces generated by the query system 110 and provided to the user device 105. The user device 105 may display the one or more user interfaces to the user via the video display.

In some implementations, the domain may include a real-world environment of the user. In such implementations, the user device 105 may capture the real-world environment of the user as images (e.g., video) of the user while the user is near the user device 105. The user device 105 may provide the images to the query system 110, and the query system 110 may receive the images. In some implementations, the query system 110 may continuously receive the images from the user device 105, may periodically receive the images from the user device 105, and/or the like. The query system 110 may identify the images as the domain associated with the user, and may process each of the images as described below in connection with a single image.

In some implementations, the domain may include a virtual reality environment of the user. In such implementations, the user device 105 or the query system 110 may generate the virtual reality environment. When the user device 105 generates the virtual reality environment, the query system 110 may receive the virtual reality environment from the user device 105 and may identify the virtual reality environment as the domain. Alternatively, when the user device 105 does not generate the virtual reality environment, the query system 110 may generate the virtual reality environment.

In some implementations, the domain may include an augmented reality environment of the user. In such implementations, the user device 105 or the query system 110 may generate the augmented reality environment. When the user device 105 generates the augmented reality environment, the query system 110 may receive the augmented reality environment from the user device 105 and may identify the augmented reality environment as the domain of the user. Alternatively, when the user device 105 does not generate the augmented reality environment, the query system 110 may generate the augmented reality environment as the domain of the user.

In some implementations, the domain may include a mixed reality environment of the user. In such implementations, the user device 105 or the query system 110 may generate the mixed reality environment. When the user device 105 generates the mixed reality environment, the query system 110 may receive the mixed reality environment from the user device 105 and may identify the mixed reality environment as the domain of the user. Alternatively, when the user device 105 does not generate the mixed reality environment, the query system 110 may generate the mixed reality environment as the domain of the user.

In some implementations, the query system 110 may generate a user interface for the domain utilized by the user device 105. The user interface may include one or more selectable objects. When the domain is the video display, the objects may include objects of a user interface displayed by the video display, such as products displayed in the user interface, services displayed in the user interface, selectable mechanisms (e.g., images, icons, links, and/or the like) of the user interface that, when selected, cause the user to move to a different user interface, exit an application, purchase a product or a service, and/or the like. When the domain is a virtual reality environment, the objects may include images virtually displayed to the user in the virtual reality environment. For example, the objects may include virtual images of products, virtual images of services, virtual selectable mechanisms (e.g., images, icons, links, and/or the like) that, when selected, cause the user to move to a different virtual reality environment, exit the virtual reality environment, purchase a product or a service of the virtual reality environment, and/or the like.

When the domain is an augmented reality environment, the objects may include images virtually displayed to the user in the augmented reality environment. For example, the objects may include virtual images of products, virtual images of services, virtual selectable mechanisms (e.g., images, icons, links, and/or the like) that, when selected, cause the user to move to a different augmented reality environment, exit the augmented reality environment, purchase a product or a service of the augmented reality environment, and/or the like. When the domain is a mixed reality environment, the objects may include images virtually displayed to the user in the mixed reality environment. For example, the objects may include virtual images of products, virtual images of services, virtual selectable mechanisms (e.g., images, icons, links, and/or the like) that, when selected, cause the user to move to a different mixed reality environment, exit the mixed reality environment, purchase a product or a service of the mixed reality environment, and/or the like.

In some implementations, the query system 110 may generate a full-screen canvas overlay, allowing users to draw around displayed objects, and may provide the user interface and the canvas to the user device 105. The user interface may overlay the canvas on a display screen of the user device 105. The canvas may enable user interaction and drawing with the user interface. The interactive canvas may span a display of the user device 105, and may enable user input on the interface. The user of the user device 105 may provide a user selection (e.g., via a drawing, a selection, a touch, and/or the like) on the user interface, and the canvas may capture the coordinates and the properties of the user selection. For example, when the user provides the user selection, the canvas or the user device 105 may identify x, y, and z coordinates utilized by an input device (e.g., a mouse, a hand, a face gesture, an eye gesture, and/or the like).

In some implementations, the query system 110 may calculate parameters for the canvas with the following syntax:

```
const canvas = document.querySelector(‘#canvas’);
// Context for the canvas for 2 dimensional operations
const ctx = canvas.getContext(‘2d’);
// Resizes the canvas to the available size of the window.
function resize( ) {
  ctx.canvas.width = window.innerWidth;
  ctx.canvas.height = window.innerHeight;
}.
```

When the domain is a user interface displayed to the user, the user selection may be generated based on one or more movements provided by a mouse cursor provided by the user device 105, a facial cursor provided by the user device 105, a hand cursor provided by the user device 105, a body movement of the user via the user device 105. When the domain is a virtual reality environment, the user selection may be generated based on movements provided by a virtual reality controller of the user device 105, a virtual reality headset of the user device 105, a head of the user (e.g., as captured by the virtual reality headset), a hand of the user (e.g., as captured by the virtual reality headset), and/or the like. When the domain is an augmented reality environment, the user selection may be generated based on one or more movements provided by an augmented reality controller of the user device 105, an augmented reality headset of the user device 105, a head of the user (e.g., as captured by the augmented reality headset), a hand of the user (e.g., as captured by the augmented reality headset), and/or the like. When the domain is a mixed reality environment, the user selection may be generated based on one or more movements provided by a mixed reality controller of the user device 105, a mixed reality headset of the user device 105, a head of the user (e.g., as captured by the mixed reality headset), a hand of the user (e.g., as captured by the mixed reality headset), and/or the like.

In some implementations, the user selection may include properties set by the user prior to or after creating the user selection. For example, the properties of the user selection may include a color (e.g., red, blue, green, and/or the like) of the user selection, a stroke pattern (e.g., a triangle, a circle, a square, and/or the like) of the user selection, a stroke width (e.g., a line width) of the user selection, a stroke dash type (e.g., solid, dashed, dotted, and/or the like) of the user selection, and/or the like. In some implementations, the properties of the user selection may be associated with intents utilized to generate a query (e.g., compare, search, provide more information, and/or the like). In some implementations, the user may also input a query regarding the user selection.

As further shown in FIG. 1A, and by reference number 120, the query system 110 may receive coordinates and properties of a user selection on the canvas by a user of the user device 105. For example, the user device 105 may provide the coordinates and the properties of the user selection to the query system 110, and the query system 110 may receive the coordinates and the properties. In some implementations, the user device 105 may provide the user selection to the query system 110, and the query system 110 may determine the coordinates and the properties based on the user selection.

In some implementations, the query system 110 may determine the coordinates based on the following syntax:

```
function getPosition(event) {
  coord.x = event.clientX − canvas.offsetLeft + window.scrollX;
  coord.y = event.clientY − canvas.offsetTop + window.scrollY;
  console.log(coord.x+“:”+coord.y)
  let pos = { }
  pos.x = coord.x
  pos.y = coord.y
  minpointarray.push(pos)
  console.log(JSON.stringify(minpointarray))
}.
```

As further shown in FIG. 1A, and by reference number 125, the query system 110 may identify an object of the user interface that is provided within the user selection defined by the coordinates. For example, the query system 110 may analyze the coordinates to determine which user interface objects are enclosed by or intersect with the user selection. In some implementations, the query system 110 may compare the coordinates with object locations on the user interface to identify objects enclosed by or intersecting with the user selection. Additionally, or alternatively, the query system 110 may process the drawing to detect objects within the boundaries of the user selection. This processing involves checking the boundaries of the drawing against the object locations. In some implementations, the query system 110 may identify user interface selectors (e.g., cascading style sheet (CSS) selectors) enclosed by or intersecting with the user selection. The query system 110 may then identify all objects that match with the identified user interface selectors. In some implementations, the query system 110 may establish a minimum boundary and/or a maximum boundary for the user selection, and may utilize these boundaries to identify objects enclosed by or intersecting with the user selection. In some implementations, the query system 110 may recognize a pattern created by the user selection. For example, the query system 110 may calculate angles between lines of the user selection, and may determine whether angles and the lines form a straight line, a triangle, a square, a rectangle, or another geometrical shape. This may enable the query system 110 to detect a drawn pattern around an object, and to generate a query based on the drawn pattern. In one example, if a sum of the angles is greater than ninety degrees) (90° and less than one hundred and eighty degrees) (180°, the query system 110 may determine that the drawn pattern is a triangle and may associate the triangle with an intent. If a sum of the angles is greater than 180° and less than three hundred and sixty degrees) (360°, the query system 110 may determine that the drawn pattern is a square or a rectangle and may associate the square/rectangle with another intent. If a sum of the angles is less than 90°, the query system 110 may determine associate the drawn pattern with still another intent. In some implementations, the query system 110 may calculate a minimum and maximum of the user selection based on the following syntax:

```
function findMinMax( ){
  min_x = Math.min(...minpointarray.map(o => o.x))
  min_y = Math.min(...minpointarray.map(o => o.y))
  max_x = Math.max(...minpointarray.map(o => o.x))
  max_y = Math.max(...minpointarray.map(o => o.y))
  console.log(min_x+“:”+min_y+“_”+max_x+“:”+max_y)
  captureImage(min_x,min_y,max_x,max_y)
  let elements =
  getElementsFromGrid(selectors,min_x,min_y,max_x,max_y)
  let ellist = [ ]
  elements.forEach(elobj => {
    console.log(“elements from draw ”+elobj.element.el.innerHTML)
    ellist.push(parseInt(elobj.element.el.innerHTML.trim( )))
    // alert(elobj.element.el.innerHTML)
  });
  let sum = Math.hypot(ellist[0], ellist[1]) // with initial value to avoid
when the array is empty
  alert(“ hypotenus of numbers : ”+ellist[0] +“ : ”+ellist[1]+“ -> ”+sum)
}.
```

In some implementations, the query system 110 may detect objects within the user selection based on the following syntax:

```
function getelementsfromdrawnsurfacearea(selector, x1, y1, x2, y2) {
  var elements = [ ];
  jQuery(selector).each(function ( ) {
    var $this = jQuery(this);
    var offset = $this.offset( );
    var x = offset.left;
    var y = offset.top;
    var w = $this.width( );
    var h = $this.height( );
    if (x >= x1 && y >= y1 && x + w <= x2 && y + h <= y2) {
      let element = { }
      element.el = $this.get(0)
      ***elements.push({
        element,
        timeofScan: new Date( ).toISOString( ),
        dateofScan: new Date( ),
        timeofPageLoad: this.timeofpageload,
        x_axis: (x + window.scrollX), y_axis: (y + window.scrollY)
      });
    }
  });
  return elements;
}.
```

In some implementations, the query system 110 may determine a drawn pattern based on the following syntax:

```
// Find the angle created between two lines
  const find_two_lines_angle = (p1_s) => {
    // Find vector components
    var dAx = points[(p1_s + 1)][0] − points[p1_s][0];
    var dAy = points[(p1_s + 1)][1] − points[p1_s][1];
    var dBx = points[(p1_s + 2)][0] − points[(p1_s + 1)][0];
    var dBy = points[(p1_s + 2)][1] − points[(p1_s + 1)][1];
    var angle = Math.atan2(dAx * dBy − dAy * dBx, dAx * dBx + dAy
    * dBy);
    if (angle < 0) {
      angle = angle * −1;
    }
    var degree_angle = 180 − (angle * (180 / Math.PI));
    // Log result
    console.log(‘Angle between the last two lines is: ’ + degree_angle);
  }
// Find the angle of the last drawn line
const find_line_angle = ( ) => {
  let dx = pos.x − point_1_x;
  let dy = pos.y − point_1_y;
  let ang = (Math.atan2(dy, dx) * 180 / Math.PI) * −1;
  // Log result
  console.log(‘Angle of last line is: ’ + ang);
}.
```

As shown in FIG. 1B, and by reference number 130, the query system 110 may determine whether the object matches a stored object based on a similarity measure (e.g., a mean squared error method). For example, the query system 110 may be associated with a data structure (e.g., a database, a table, a list, and/or the like) that includes stored objects that may be utilized with user interfaces. The query system 110 may analyze the object within the user selection, and may compare the object with the stored objects using a similarity measure, such as a mean squared error method, to identify similarities. For example, the query system 110 may calculate a mean squared error between a vectorized form of the object and a stored vectorized object to determine whether the object matches the stored object.

In some implementations, the query system 110 may utilize a classifier (e.g., a neural network classifier) to determine whether the object matches a stored object. For example, the query system 110 may utilize the neural network classifier to identify similarities between the object and a stored object. The neural network classifier may include a trained neural network that determines whether objects match. Additionally, or alternatively, the query system 110 may utilize a k-nearest neighbors (k-NN) model to determine whether the object matches a stored object. For example, the query system 110 may utilize the k-NN model to identify similarities between the object and a stored object based on nearest neighbors in a feature space. Additionally, or alternatively, the query system 110 may utilize a cosine similarity metric to determine whether the object matches a stored object. For example, the query system 110 may utilize the cosine similarity metric to identify how closely the object matches the stored object based on vector space models. Additionally, or alternatively, the query system 110 may utilize a support vector machine (SVM) classifier to determine whether the object matches a stored object. In some implementations, the query system 110 may determine that the object fails to match a stored object. Alternatively, the query system 110 may determine that the object matches a stored object.

As further shown in FIG. 1B, and by reference number 135, the query system 110 may generate object text for the object based on determining that the object fails to match a stored object. For example, if the query system 110 determines that the object fails to match any stored object, the query system 110 may generate descriptive object text for the object based on analyzing features and characteristics of the object. In some implementations, the query system 110 may utilize natural language processing techniques to generate the object text for the object. For example, the query system 110 may generate the object text for the object by identifying features of the object and applying natural language generation models to the identified features. Additionally, or alternatively, the query system 110 may utilize a predefined template to generate the object. For example, the query system 110 may generate object text for the object using one or more predefined templates that include object characteristic data. Additionally, or alternatively, the query system 110 may utilize an attribute extraction model to generate the object text for the object. For example, the query system 110 may generate object text for the object by extracting attributes of the object and compiling the attributes into a coherent description.

As further shown in FIG. 1B, and by reference number 140, the query system 110 may retrieve stored object text associated with a stored object based on determining that the object matches the stored object. For example, if the query system 110 determines that the object matches a stored object, the query system 110 may retrieve (e.g., from the data structure) pre-existing stored object text associated with the stored object. In some implementations, the query system 110 may utilize a hash-based lookup of the data structure to retrieve the stored object text associated with the stored object. Additionally, or alternatively, the query system 110 may utilize an indexed data structure search to retrieve the stored object text associated with the stored object. Additionally, or alternatively, the query system 110 may utilize a semantic search technique (e.g., that considers a meaning and a context of object attributes) to retrieve the stored object text associated with the stored object.

As shown in FIG. 1C, and by reference number 145, the query system 110 may generate a query for the object based on the properties of the user selection and the object text or the stored object text. For example, the query system 110 may analyze the properties of the user selection (e.g., the color, the stroke pattern, the stroke width, and the stroke dash type), and may utilize the properties to determine an intent of the user. The query system 110 may utilize the intent of the user and the object text (or the stored object text if available) to generate the query. Additionally, or alternatively, the query system 110 generate the query based solely on the properties of the user selection, based solely on the object text, or based solely on the stored object text. Additionally, or alternatively, the query system 110 may generate the queries by incorporating attributes, such as subjects, actions, objects, places, times, or characteristics, into the query to reflect the user's intent accurately. This may include categorizing elements of the object into subjects, actions, objects, places, times, or characteristics, and forming a coherent query based on these elements. Additionally, or alternatively, the generated query may be designed to interact with different interface elements, such as digital surfaces on mobile devices, desktops, or augmented reality displays. The generated query may facilitate the retrieval of appropriate information or responses by reflecting the user's intent. This may ensure that the query system 110 can provide precise and relevant responses based on the user's intent.

As shown in FIG. 1D, and by reference number 150, the query system 110 may process the query, with a language model (e.g., a large language model (LLM), a small language model (SLM), and/or the like), to generate a response to the query. For example, the query system 110 may apply the query to an LLM trained to understand and generate human-like text based on a vast amount of data. The LLM may interpret the query, considering the context and the properties of the user selection, and may produce a coherent and relevant response. The response may include detailed information, suggested actions, or any other relevant data that aligns with the user's intent as inferred from the query. The use of an LLM may enable the query system 110 to handle complex queries and generate accurate responses, enhancing the overall user interaction with the query system 110.

In some implementations, the query system 110 may utilize a machine learning model to interpret the query and generate the response. A machine learning model can learn from historical data and improve over time, allowing for more accurate and contextually relevant responses to user queries. Additionally, or alternatively, the query system 110 may utilize a neural network model to analyze the query and produce a relevant response based on the user selection. A neural network model may process large amounts of data through interconnected nodes, making the model effective in understanding complex patterns within the query. Additionally, or alternatively, according to FIG. 1D, the query system 110 may process the query using artificial intelligence (AI) techniques to generate the response. AI techniques may include various methods, including expert systems and reinforcement learning, that provide intelligent responses tailored to queries.

Additionally, or alternatively, the query system 110 may utilize a deep learning model to understand and generate the response to the query. A deep learning model, such as a convolutional neural network (CNN) and a recurrent neural network (RNN), may be particularly effective in processing and interpreting the query. Additionally, or alternatively, the query system 110 may employ natural language processing to interpret the query and generate the response. Natural language processing techniques may enable the query system 110 to understand and generate human language, facilitating more natural and intuitive interactions. Additionally, or alternatively, the query system 110 may utilize a cognitive computing system to analyze and generate the response to the query. A cognitive computing system may mimic human thought processes and can adapt to new information, providing sophisticated and context-aware responses.

Additionally, or alternatively, the query system 110 may apply a conversational AI model to process the query and provide the response. A conversational AI model may be designed to simulate human conversation, making the interaction more engaging and user-friendly. Additionally, or alternatively, the query system 110 may utilize a predictive model to generate a response based on the analysis of the query. A predictive model may forecast outcomes based on historical data, enhancing the relevance and accuracy of the responses. Additionally, or alternatively, the query system 110 may utilize a context-aware system to interpret and generate the response to the query. A context-aware system may consider the situational context of the query, ensuring that responses are pertinent to a current environment and needs of the user. Additionally, or alternatively, the query system 110 may utilize a hybrid model combining rule-based and machine learning techniques to process and generate the response to the query. A hybrid model may leverage the strengths of both rule-based systems and machine learning, offering a balanced approach to query processing and response generation.

As shown in FIG. 1E, and by reference number 155, the query system 110 may provide the response for display to the user device 105 via the user interface. For example, after generating the response to the query, the query system 110 may provide the response to the user device 105. The user device 105 may display the response to the user via the user interface. This interaction may enable the user to receive immediate and contextually relevant information directly on the user device 105, enhancing the overall user experience by providing efficient and intuitive access to desired data. In some implementations, the query system 110 may format the response to fit display parameters of the user device 105, prior to providing the response to the user device 105. This may ensure that the information is presented clearly and concisely on the user device 105. In some implementations, the response may include various formats, such as text, images, or interactive elements to enhance user engagement. As shown in FIG. 1E, the response may include further information about a device (e.g., a tablet) provided with a user selection. In one example, the further information may indicate that the tablet is the most popular with customers, and request if more information about the tablet is required.

FIG. 1F depicts an example user interface that may be generated by the query system 110 and displayed by the user device 105. For example, the user interface may allow the user to select properties for the user selection, such as a color (e.g., black), a width (e.g., 2.5 pt), and a dash type (e.g., dashed). As further shown in FIG. 1F, the user interface may include various devices (e.g., device 1, device 2, device 3, device 4, and device 5) with their respective features and prices. Additionally, or alternatively, the query system 110 may display the selected devices along with their prices and features, enabling the user to compare them easily. For example, the comparison can show side-by-side features like battery life, screen size, and price for each device.

As further shown in FIG. 1F, the user may draw a user selection around multiple devices using a specified drawing property, such as a dashed line, to indicate the user selection. For example, the user may draw around device 3 and device 4, as indicated by the dashed shape in FIG. 1F. Additionally, or alternatively, the user may use different types of strokes (e.g., dashed or solid lines) to draw a selection around devices, and the query system 110 may interpret the selection accordingly. For example, a solid line might indicate a primary selection while a dashed line could indicate a secondary selection. Additionally, or alternatively, the user may draw around any combination of the devices to indicate the selection. For example, the user could draw around device 1, device 2, and device 5 to create a custom selection for comparison. The query system 110 may then interpret this user selection and generate a query based on the properties of the selection and the device representations enclosed by the selection.

As further shown in FIG. 1F, the query system 110 may process the user selection to generate a query, which may be displayed to the user via a query bubble. For example, the query bubble may ask a question (e.g., “can you compare the features of these devices?”) indicating that the query system has understood the user's intent and is ready to provide a comparison of the features of device 3 and device 4. Additionally, or alternatively, the query generated by the query system 110 may be tailored to the specific display parameters of the user device 105 to ensure clarity and ease of understanding. For example, the text size and format of query may adjust based on the screen size of the user device 105 to provide an optimal viewing experience. Additionally, or alternatively, the query system 110 may present the query in various formats, including text, images, or interactive elements, to enhance the user experience.

FIG. 1G depicts an example user interface that may be generated by the query system 110 and displayed by the user device 105. For example, after generating the response to the query of FIG. 1F, the query system 110 may provide the response to the user device 105. In some implementations, the response generated by the query system 110 may be displayed on a user device 105 via the user interface, allowing the user to easily access and view the response. This interaction may enable the user to receive immediate and contextually relevant information directly on the user device 105, enhancing the overall user experience by providing efficient and intuitive access to desired data. In some implementations, the query system 110 may format the response to fit display parameters of the user device 105, prior to providing the response to the user device 105. This may ensure that the information is presented clearly and concisely on the user device 105. Additionally, or alternatively, the displayed response on the user device 105 may include various formats, such as text, images, or interactive elements, to increase user engagement.

As further shown in FIG. 1G, the response may include further information about the selected devices (e.g., device 3 and device 4) provided within the user selection. The further information may include specifications, user reviews, and related accessories associated with the selected devices. In one example, the response may indicate that device 3 has features A, B, and C, while device 4 has features B, X, and Y. In this way, the user may easily compare the features of the selected devices. Additionally, or alternatively, the response may be dynamically updated on the user device 105 based on further interactions or queries from the user. This dynamic updating can provide real-time insights and adjustments to the information presented. Additionally, or alternatively, the user interface may allow the user to interact with the response, such as clicking on links or buttons to access more information. This interactivity may lead to a more engaging and informative user experience.

In some implementations, the query system 110 may automatically generate images from the user selection. For example, the query system 110 may generate multiple possible images inside the user selection. The query system 110 may crop the image drawn around by the user selection, and may create separate images which are part of the cropped image. The query system 110 may generate multiple images inside the user selection and may download or stream the multiple images to a different system over a network. Automatically generating images directly from the user selection may reduce the overhead of cropping images from a generated image. This involves capturing the coordinates of the selection, identifying the objects within the area, and then cropping and creating separate images for the objects. By focusing only on the selected area, the query system 110 avoids processing the entire image, thereby reducing computational load and speeding up the image processing tasks.

In some implementations, the query system 110 may automatically generate images from the user selection based on the following syntax:

```
function findMinMax( ){
  min_x = Math.min(...minpointarray.map(o => o.x))
  min_y = Math.min(...minpointarray.map(o => o.y))
  max_x = Math.max(...minpointarray.map(o => o.x))
  max_y = Math.max(...minpointarray.map(o => o.y))
  console.log(min_x+“:”+min_y+“_”+max_x+“:”+max_y)
  let elements =
getElementsFromDrawnSurfaceArea(selectors,min_x,min_y,max_x,max_y)
  let ellist = [ ]
//iterate on every node element to generate image of the node
  elements.forEach(elobj => {
    generateImagesfromtheselectedarea(elobj.element.el)
      console.log(“elements from draw ”+elobj.element.el.innerHTML)
      if(parseInt(elobj.element.el.innerHTML.trim( ))){
      ellist.push(parseInt(elobj.element.el.innerHTML.trim( )))
      }
      // alert(elobj.element.el.innerHTML)
    });
    let sum = Math.hypot(...ellist) // with initial value to avoid when the array
  is empty
    alert(“ hypotenus is ”+sum)
  }
function generateImagesfromtheselectedarea(el){
  convertdomelement.toJpeg(el, { quality: 0.95 })
  .then(function (dataUrl) {
    var link = document.createElement(‘a’);
    link.download = new Date( ).toISOString( )+‘.jpeg’;
    link.href = dataUrl;
    link.click( );
  });
}.
```

In some implementations, the query system 110 may generate an image that is part of the user selection using domain nodes by cloning a node and creating the canvas with the cloned node and transforming to blob data and to draw the image out of the canvas. The query system 110 may generate the image based on the following code:

```
function generateImagefromDomelement(domNode, options) {
  return toSvg(domNode, options)
    .then(util.makeImage)
    .then(util.delay(100))
    .then(function (image) {
      var canvas = newCanvas(domNode);
      canvas.getContext(‘2d’).drawImage(image, 0, 0);
      return canvas;
    });
  function newCanvas(domNode) {
    var canvas = document.createElement(‘canvas’);
    canvas.width = options.width || util.width(domNode);
    canvas.height = options.height || util.height(domNode);
    if (options.bgcolor) {
      var ctx = canvas.getContext(‘2d’);
      ctx.fillStyle = options.bgcolor;
      ctx.fillRect(0, 0, canvas.width, canvas.height);
    }
    return canvas;
  }
}.
```

In some implementations, the query system 110 may be utilized for application build testing. For example, the query system 110 may be utilized to capture a part of domain elements and to transform them into an image. The image may be utilized for image comparison for user acceptance testing of applications. The image comparison may determine images that are part of a previous build versus a current build. In some implementations, the query system 110 may be utilized in user acceptance testing (UAT) by capturing parts of the user interface as images based on user selections. The query system 110 may use the images for comparison between different builds of an application. By comparing images from previous and current builds, testers can identify discrepancies or changes in the user interface, ensuring that the application meets the required specifications and functions correctly. This automated image capture and comparison may streamline the UAT process, making it more efficient and accurate.

In some implementations, the query system 110 may crop and drag and drop a portion of an image to another system, such as a system for querying against the portion of the image instead of the entire new image. In some implementations, the query system 110 may be utilized to query against a drawing pattern and elements captured against a surface area, and to summarize the query and the response using a digital avatar or any other personalized user experience. In some implementations, the query system 110 may be utilized with smart tables or smart mirrors to query against a drawn surface area by using hand gestures or facial gestures.

In this way, the query system 110 (and/or the user device 105) provides an enhanced user interface for selecting user interface elements and generating a query based on the selection. For example, the query system 110 may provide a form of interaction that goes beyond mere point-and-click or single element selection. The query system 110 may accurately interpret user intent through freeform drawing gestures, and may provide relevant information while enhancing the overall user experience. By interpreting gestural inputs to generate queries, the query system 110 may minimize a need for textual input and may reduce a quantity of steps typically required to obtain information. By streamlining the interaction process, the query system 110 may be advantageous in environments with high data throughput, such as e-commerce platforms, digital catalogs, and multimedia applications. Thus, the query system 110 may conserve computing resources, networking resources, and/or other resources that would have otherwise been consumed by failing to determine an intent of a user searching for information, providing incorrect information to the user based on failing to determine the intent of the user, handling user complaints associated with providing incorrect information, handling lost customers associated with providing incorrect information, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

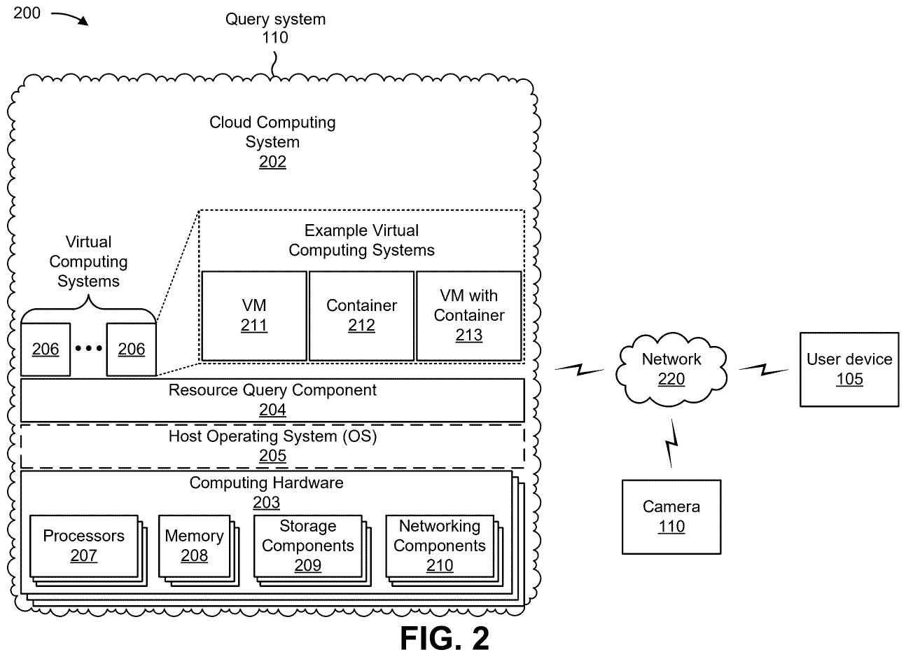

FIG. 2 is a diagram of an example environment 200 in which systems and/or methods described herein may be implemented. As shown in FIG. 2, the environment 200 may include the query system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device. In some implementations, the user device 105 may include a camera that captures images, audio, and/or videos (e.g., images and audio). The camera may feed real-time images and/or video directly to the user device 105 or the display of the user device 105, may record captured images and/or video to a storage device for archiving or further processing, and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

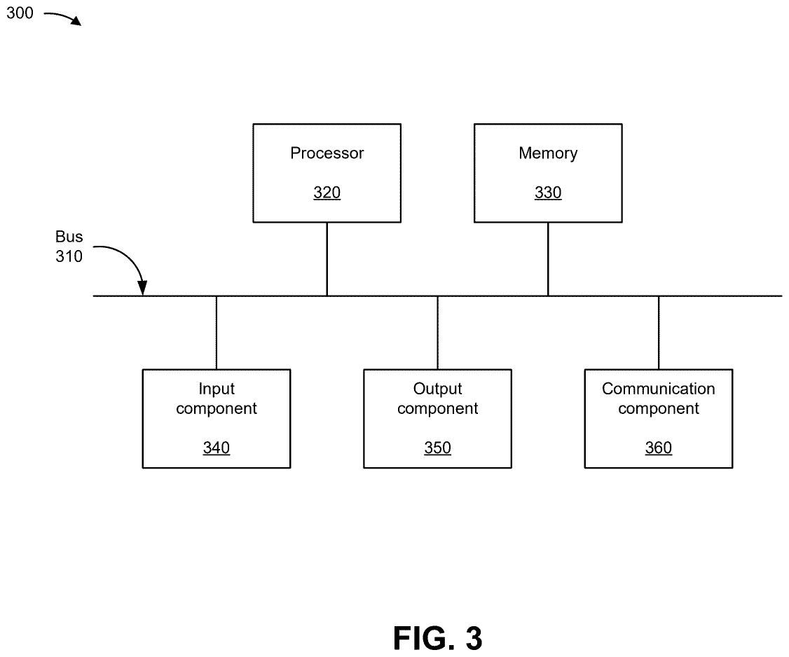

Although the query system 110 may include one or more elements 203-213 of the cloud computing system 202, may execute within the cloud computing system 202, and/or may be hosted within the cloud computing system 202, in some implementations, the query system 110 may not be cloud-based (e.g., may be implemented outside of a cloud computing system) or may be partially cloud-based. For example, the query system 110 may include one or more devices that are not part of the cloud computing system 202, such as the device 300 of FIG. 3, which may include a standalone server or another type of computing device. The query system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the query system 110. In some implementations, the user device 105 and/or the query system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

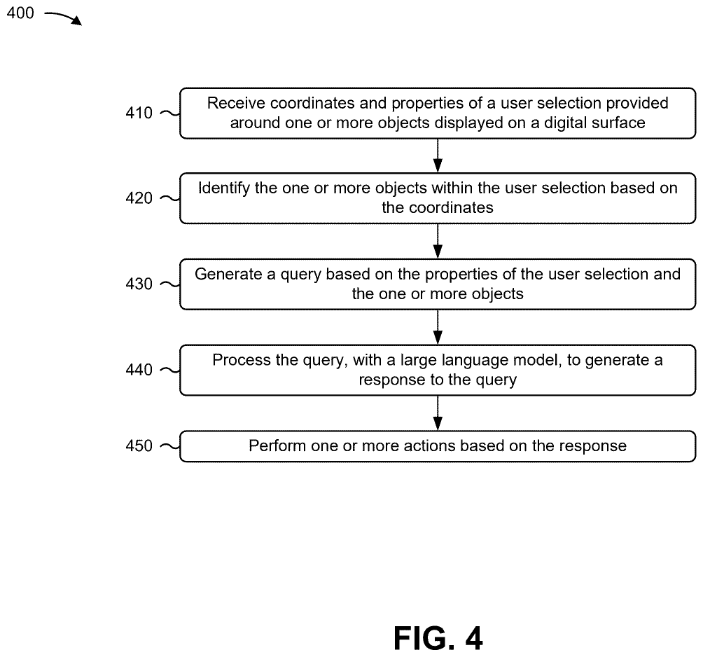

FIG. 4 is a flowchart of an example process 400 for providing an enhanced user interface for selecting user interface elements and generating a query based on the selection. In some implementations, one or more process blocks of FIG. 4 may be performed by a device (e.g., the query system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving coordinates and properties of a user selection provided around one or more objects displayed on a digital surface (block 410). For example, the device may receive coordinates and properties of a user selection provided around one or more objects displayed on a digital surface, as described above. In some implementations, receiving the user selection includes receiving the user selection based on an input, from one or more of a hand, a mouse, a face, or a gesture, that generates the user selection around the one or more objects displayed on the digital surface. In some implementations, the properties of the user selection include one or more of a color of the user selection, a stroke pattern of the user selection, a stroke width of the user selection, or a stroke dash type of the user selection. In some implementations, the digital surface includes one or more of a display of a mobile device, a desktop, a web interface, a display of an augmented reality device, or a display of a virtual reality device.

As further shown in FIG. 4, process 400 may include identifying the one or more objects within the user selection based on the coordinates (block 420). For example, the device may identify the one or more objects within the user selection based on the coordinates, as described above. In some implementations, identifying the one or more objects within the user selection includes identifying the one or more objects within the user selection based on selectors and boundary conditions of the digital surface.

As further shown in FIG. 4, process 400 may include generating a query based on the properties of the user selection and the one or more objects (block 430). For example, the device may generate a query based on the properties of the user selection and the one or more objects, as described above. In some implementations, generating the query based on the properties of the user selection and the one or more objects includes categorizing elements of the one or more objects into one or more of subjects, actions, objects, places, times, or characteristics, and generating the query based on the one or more of the subjects, the actions, the objects, the places, the times, or the characteristics. In some implementations, the properties of the user selection are associated with intents utilized to generate the query.

As further shown in FIG. 4, process 400 may include processing the query, with a large language model, to generate a response to the query (block 440). For example, the device may process the query, with a large language model, to generate a response to the query, as described above.

As further shown in FIG. 4, process 400 may include performing one or more actions based on the response (block 450). For example, the device may perform one or more actions based on the response, as described above. In some implementations, performing the one or more actions includes one or more of providing the response to a first device of a user that generated the user selection, providing the response to a second device of an agent of the user that generated the user selection, or providing the response to the first device and the second device.

In some implementations, process 400 includes identifying one of the one or more objects that matches a stored object, retrieving stored object text associated with the stored object, and generating the query based on the stored object text, the properties of the user selection, and the one or more objects. In some implementations, process 400 includes generating object text describing the one or more objects, and generating the query based on the object text and the properties of the user selection.

In some implementations, process 400 includes identifying one or more elements in the image from the selected region, and cropping one or more images, from the image, corresponding to the one or more elements identified in the image. In some implementations, process 400 includes overlaying a canvas on the digital surface, wherein the canvas covers a width, a height, and a depth of the digital surface.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a device, coordinates and properties of a marking provided around one or more objects displayed on a digital surface, wherein the marking corresponds to a user selection;
identifying, by the device, the one or more objects within the user selection based on the coordinates;
determining, by the device, an intent of the user selection based on the properties of the marking;
generating, by the device, a query based on the intent of the user selection and the one or more objects;
processing, by the device, the query, with a large language model, to generate a response to the query; and
performing, by the device, one or more actions based on the response.

2. The method of claim 1, further comprising:
identifying one of the one or more objects that matches a stored object; and
retrieving stored object text associated with the stored object,
wherein generating the query comprises:
generating the query based on the stored object text, the properties of the marking, and the one or more objects.

3. The method of claim 1, further comprising:
generating object text describing the one or more objects,
wherein generating the query comprises:
generating the query based on the object text and the properties of the marking.

4. The method of claim 1, wherein receiving the user selection comprises:
receiving the user selection based on an input, from one or more of a hand, a mouse, a face, or a gesture, that generates the marking around the one or more objects displayed on the digital surface.

5. The method of claim 1, wherein the properties of the marking include one or more of a color of the marking, a stroke pattern of the marking, a stroke width of the marking, or a stroke dash type of the marking.

6. The method of claim 1, wherein identifying the one or more objects within the user selection comprises:
identifying the one or more objects within the user selection based on selectors and boundary conditions of the digital surface.

7. The method of claim 1, wherein generating the query based on the properties of the user selection and the one or more objects comprises:
categorizing elements of the one or more objects into one or more of subjects, actions, objects, places, times, or characteristics; and
generating the query based on the one or more of the subjects, the actions, the objects, the places, the times, or the characteristics.

8. A device, comprising:
one or more processors configured to:
receive coordinates and properties of a marking provided around one or more objects displayed on a digital surface,
wherein the coordinates and the properties of the marking are received based on an input, from one or more of a hand, a mouse, a face, or a gesture, that generates the marking around the one or more objects displayed on the digital surface, and
wherein the marking corresponds to a user selection;
identify the one or more objects within the user selection based on the coordinates;
determine an intent of the user selection based on the properties of the marking;
generate a query based on the intent of the user selection and the one or more objects;
process the query, with a large language model, to generate a response to the query; and
perform one or more actions based on the response.

9. The device of claim 8, wherein the one or more processors are further configured to:
receive a selection of a selected region within the user selection; and
generate a visual representation of an image from the selected region within the user selection.

10. The device of claim 9, wherein the one or more processors are further configured to:
identify one or more elements in the image from the selected region; and
crop one or more images, from the image, corresponding to the one or more elements identified in the image.

11. The device of claim 8, wherein the one or more processors, to perform the one or more actions, are configured to:
provide the response to a first device of a user that generated the marking;
provide the response to a second device of an agent of the user that generated the marking; or
provide the response to the first device and the second device.

12. The device of claim 8, wherein the digital surface includes one or more of a display of a mobile device, a desktop, a web interface, a display of an augmented reality device, or a display of a virtual reality device.

13. The device of claim 8, wherein the properties of the marking are associated with intents utilized to generate the query.

14. The device of claim 8, wherein the one or more processors are further configured to:
overlay a canvas on the digital surface, wherein the canvas covers a width, a height, and a depth of the digital surface.

15. A non-transitory computer-readable medium storing a set of instructions, the set of instructions comprising:
one or more instructions that, when executed by one or more processors of a device, cause the device to:
receive coordinates and properties of a marking provided around one or more objects displayed on a digital surface,
wherein the marking corresponds to a user selection, and
wherein the digital surface includes one or more of a display of a mobile device, a desktop, a web interface, a display of an augmented reality device, or a display of a virtual reality device;
identify the one or more objects within the user selection based on the coordinates;
determine an intent of the user selection based on the properties of the marking;
generate a query based on the intent of the user selection and the one or more objects;
process the query, with a large language model, to generate a response to the query; and
perform one or more actions based on the response.

16. The non-transitory computer-readable medium of claim 15, wherein the one or more instructions further cause the device to:
identify one of the one or more objects that matches a stored object; and
retrieve stored object text associated with the stored object,
wherein the one or more instructions, that cause the device to generate the query, cause the device to:
generate the query based on the stored object text, the properties of the marking, and the one or more objects.

17. The non-transitory computer-readable medium of claim 15, wherein the one or more instructions further cause the device to:
generate object text describing the one or more objects,
wherein the one or more instructions, that cause the device to generate the query, cause the device to:
generate the query based on the object text and the properties of the marking.

18. The non-transitory computer-readable medium of claim 15, wherein the one or more instructions, that cause the device to identify the one or more objects within the user selection, cause the device to:
identify the one or more objects within the user selection based on selectors and boundary conditions of the digital surface.

19. The non-transitory computer-readable medium of claim 15, wherein the one or more instructions, that cause the device to generate the query based on the properties of the user selection and the one or more objects, cause the device to:
categorize elements of the one or more objects into one or more of subjects, actions, objects, places, times, or characteristics; and
generate the query based on the one or more of the subjects, the actions, the objects, the places, the times, or the characteristics.

20. The non-transitory computer-readable medium of claim 15, wherein the one or more instructions, that cause the device to perform the one or more actions, cause the device to:
provide the response to a first device of a user that generated the user selection;
provide the response to a second device of an agent of the user that generated the user selection; or
provide the response to the first device and the second device.
